(19) United States
(12) Patent Application Publication
(10) Pub. No.: US 2007/0018598 A1
(43) Pub. Date: Jan. 25, 2007

(54) Method of Operating a Three Phase Sensorless Brushless Motor

(76) Inventor: Martin Peter Nichols, Christchurch (NZ)

Correspondence Address: DYKEMA GOSSETT PLLC, 39577 WOODWARD AVENUE, SUITE 300, BLOOMFIELD HILLS, MI, 48304-5086, US

(21) Appl. No.: 11/425,478

(22) Filed: Jun. 21, 2006

(30) Foreign Application Priority Data
Jun. 30, 2005 (GB) 0513356.6

(51) Int. Cl. H02P 25/12

(52) U.S. Cl. 318/439

(57) ABSTRACT

A method of operating a three phase sensorless brushless motor including a stator including three phase windings and a rotor carrying at least one permanent magnet, the method including switching power to the phase windings of the stator in synchronisation with the rotor position, by applying voltage strokes to the windings, to generate a rotating magnetic flux which interacts with the rotor flux generated by the rotor magnet, to rotate the rotor, the method including applying a plurality of voltage strokes to each of the windings for each rotation of the rotor, sensing a position of the rotor by detecting back emf voltage transitions in a third only of the windings in periods in which voltage strokes are not applied to the third winding, and estimating when the rotor is expected to have rotated though a predetermined angle to a position at which a voltage stoke is next to be applied to the or another winding, and applying the voltage stroke at the estimated time.

This application claims priority to United Kingdom Patent Application No. 0513356.6 filed Jun. 30, 2005, the entire disclosure of which is incorporated herein by reference.

### BACKGROUND TO THE INVENTION

This invention relates to a method of operating a three phase sensorless brushless motor.

### DESCRIPTION OF THE PRIOR ART

Three phase sensorless brushless motors are known for example, from U.S. Pat. No. 6,570,353. In a conventional such arrangement, each of the phases of the stator windings are excited in turn by the application of voltage strokes, with typically two of the phases being powered simultaneously with the remaining phase “floating” i.e. no voltage stroke is applied, so that back emf's induced in the remaining phase winding, may be sensed to provide an indication of rotor position. Thus all three of the windings not only are used for torque generation, but for rotor position sensing. Conventionally such motors have been operated according to a six-step commutation, i.e. each winding has been excited twice for each electrical revolution, and power is applied to each winding for two-thirds of the time, with each winding being used for rotor position sensing during the remaining third of the electrical revolution.

However in more sophisticated motor design, as exemplified in U.S. Pat. No. 6,570,353, each winding may be excited more than twice for each electrical revolution, for example four times, so that the motor is twelve step commutated, in an effort to smooth out torque ripples which can lead to excessive current ripple and acoustic noise in six step commutated arrangements.

### SUMMARY OF THE INVENTION

According to one aspect of the present invention we provide a method of operating a three phase sensorless brushless motor including a stator including three phase windings and a rotor carrying at least one permanent magnet, the method including switching power to the phase windings of the stator in synchronisation with the rotor position, by applying voltage strokes to the windings, to generate a rotating magnetic flux which interacts with the rotor flux generated by the rotor magnet, to rotate the rotor, the method including applying a plurality of voltage strokes to each of the windings for each rotation of the rotor, sensing a position of the rotor by detecting back emf zero voltage transitions in a third only of the windings in periods in which voltage strokes are not applied to the third winding, and estimating when the rotor is expected to have rotated though a predetermined angle to a position at which a voltage stoke is next to be applied to the or another winding, and applying the voltage stroke at the estimated time.

Thus utilising the method of the invention, the first and second stator windings may permanently be excited by voltage strokes, with the third winding only being used for rotor position sensing in “floating” periods of the rotor rotation when no voltage stroke is applied to the third winding.

The invention has particularly but not exclusively been developed for use in a twelve step commutation method. Although U.S. Pat. No. 6570353 teaches a twelve step commutation scheme, voltage strokes are not applied to two of the three stator windings over all twelve step positions, but to each winding over ten step positions only. Thus each winding has two “floating” periods corresponding to step positions in which power is not switched to the respective winding. However each period of float is short and thus the arrangement is prone to missing back emf zero voltage transitions particularly at high motor speeds, when misfiring can occur.

It is desirable to be able to operate existing three phase sensorless brushless motors by the method of the invention; in the prior proposal, additional hardware is required for back emf voltage transition detecting, which makes the proposal more complicated for general use.

Moreover, in the prior proposal, each winding generates torque for only ten-twelfths of the time. There is an inherent problem with low voltage motors such as are for automotive use, when back emf s can provide a significant obstacle to torque generation, particularly in the event of a diminished automotive battery performance. Accordingly it is desirable to maximise torque generation in each of the windings. The present invention achieves this as torque is generated by the first and second windings all of the time and for two-thirds of the time in the third winding.

The method of the present invention preferably includes applying to at least the first and second windings, a plurality of voltage strokes of different magnitude and direction over each electrical revolution, depending upon the rotor position sensed or estimated.

For example in each electrical revolution, the first and second windings may each receive a relatively strong voltage stroke in a first direction over a plurality of step positions, followed by a relatively weaker voltage stroke in the first direction over at least one step position, followed by a weak voltage stroke in a second opposite direction over at least one step position, followed by a strong voltage stroke in the second direction over a plurality of step positions, followed by a weaker voltage stroke in the second direction over at least one step position, followed by a weak voltage stroke in the first direction over at least one step position.

Preferably the strong voltage strokes are applied over four adjacent step positions, and the weaker voltage strokes are each applied over a single step position, and the voltage strokes applied in the first and second windings may be offset in the electrical rotation by four step positions to one another.

A strong voltage stroke in the first direction may be applied to the third stator winding over a plurality of step positions, followed by a floating period over preferably two step positions, followed by a strong voltage stroke in the second direction, followed by another floating period over preferably two step positions. Thus each strong voltage stroke applied to the third winding in the first and second directions may be applied for four step positions. Each strong voltage stroke applied to the third winding may be followed by a corresponding high voltage stroke in a corresponding first or second direction, in one of the first and second windings.

According to a second aspect of the invention we provide a method of operating a three phase sensorless brushless motor during start up, the motor including a stator including three phase windings and a rotor carrying at least one permanent magnet, the method including applying a voltage stroke to at least one of the windings to bring the rotor to a reference start angular position relative to the stator windings, applying voltage strokes to the windings according to a set commutation scheme irrespective of any rotor position to establish rotation of the motor until a plurality of back emf voltage transitions are sensed, then applying voltage strokes to each of the windings in synchronisation with the rotor position, and detecting back emf zero voltage transitions in a third only of the windings in a period in which voltage strokes are not applied to the third winding, and estimating when the rotor is expected to have rotated though a predetermined angle to a position at which a voltage stoke is next to be applied to the or another winding, and applying the voltage stroke at the estimated time.

The start-up method may include, upon a plurality of back emf voltage transitions being sensed, for a predetermined period or until the motor speed has reached a predetermined value, applying voltage strokes to each of the three windings such that in each electrical revolution, each winding has at least one floating period during which no power is applied, and detecting back emf zero voltage transitions in each of the windings in respective floating periods.

The method of operating the motor may include switching between a commutation method in which voltage strokes are applied to each of the three windings such that in each electrical revolution, each winding has at least one floating period during which no power is applied, and detecting back emf zero voltage transitions in each of the windings in respective floating periods, and the commutation method of the first aspect of the invention.

### BRIEF DESCRIPTION OF THE DRAWINGS

Embodiments of the present invention will now be described with reference to the accompanying drawings in which:

FIG. 1 illustrates a six step commutation of a conventional three phase sensorless brushless electric motor in which position sensing of the rotor is achieved by sensing in all three phase stator windings;

FIG. 2 illustrates a twelve step commutation of a motor operated by the method of the present invention.

### DESCRIPTION OF THE PREFERRED EMBODIMENTS

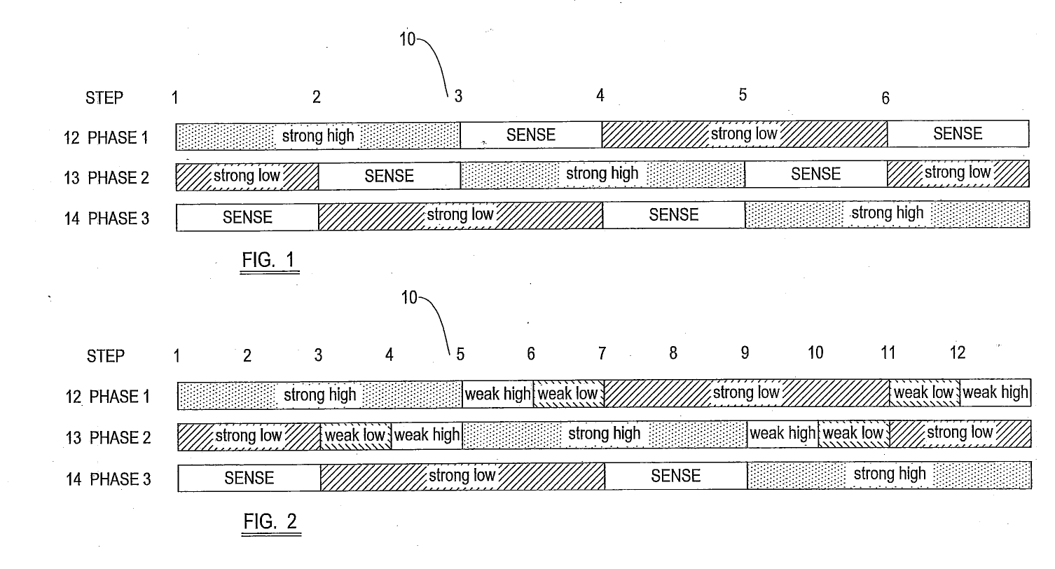

Referring to FIG. 1, a conventional three phase sensorless brushless electric motor 10 is illustrated which has three stator windings, illustrated at 12, 13 and 14. The windings are electrically displaced by 120° about an axis of rotation of a rotor which carries one or more permanent magnets. The motor 10 is operated so that power is in turn switched to all three phase windings 12, 13, 14 of the stator in turn, in synchronism with the rotor position, the rotor position being determined by detecting zero voltage transitions of back emf's induced in each of the windings 12, 13, 14.

The motor 10 is six step commutated with each winding 12, 13, 14 being excited twice in each electrical revolution, to generate a rotating magnetic flux which interacts with a rotor flux generated by the rotor magnet or magnets, to create a torque to rotate the rotor. To balance the rotor torque, it is usual for positive or negative voltage pulses (from a datum level) to be applied. These voltage strokes are in the drawings designated “high” and “low” respectively depending on their direction from the datum or zero voltage level. In this conventional example, the magnitude of the voltage stroke when applied, is always the same, albeit high or low, and the magnitude of the voltage strokes are thus designated “strong”.

Thus in the figure, it can be seen that at a predetermined rotor position, a first phase winding 12 is provided with a strong high voltage stroke which is maintained for two steps of the rotor. Then, there is a “floating” period during which no voltage stroke is applied to the first stator winding 12, but rather the phase winding 12 is used for sensing the rotor position, by detecting back emf's induced in the phase winding as the rotor (magnet) rotates in the stator flux.

Such determination of rotor position may be made by determining when the induced back emf's change from positive to negative voltages i.e. the back emf's pass through zero voltage, i.e. so called back emf zero voltage transitions, which transitions will correspond to an absolute rotor angular position relative to the stator. After the floating period i.e. when the winding 12 is used for sensing rotor position and power is not switched to the phase winding 12, another voltage stroke is applied, this time a strong low voltage stroke. This is maintained for two step positions too, when power is again switched out of the first winding 12 and the first winding is used for rotor position sensing.

Meanwhile, during the first step position when the first winding 12 is receiving a strong high voltage stroke, the second winding 13 receives a strong low voltage stroke whilst the third winding 14 is used for rotor position sensing.

During the second step position, the second winding 13 is used for rotor position sensing while a strong low voltage stroke is applied to the third winding 14.

During the third step position while the first winding 12 is used for rotor position sensing, the second winding 13 receives a strong high voltage stroke whilst the third winding 14 continues to receive a strong low voltage stroke.

During the fourth step position while the first winding 12 receives a strong low voltage stroke, the second winding 13 continues to receive the strong high voltage stroke while the third winding 14 is used for rotor position sensing.

During the fifth step position the second winding 13 is switched to rotor position sensing while the third winding 14 receives a strong high voltage stroke.

During the sixth step position, while the first winding 12 is used for rotor position sensing, the second winding 13 receives a strong low voltage stroke while the third winding 14 continues to receive a strong high voltage stroke.

It will be appreciated by those skilled in the art that in actuality, there may be several electrical rotations for each mechanical rotor rotation, and that the stepping sequence described would in that case, relate to the electrical rotational steps, but with each winding 12, 13, 14 being used to sense absolute rotor position by determining back emf zero voltage transitions. For example, in a four pole pair motor, there are four electrical revolutions per mechanical rotor revolution, but the invention is applicable to other three phase brushless sensorless motor arrangements.

It is known to reduce torque ripple e.g. in an effort to reduce acoustic noise, by increasing the number of electrical steps for each electrical revolution to twelve steps. However a twelve step motor which operates upon a commutation similarly to that described above for the prior art six step motor, would require significant processing power, and a multiplicity of components. It will be appreciated that typically the motor controller controls the motor 10 digitally for accuracy, but that the induced back emf's are analogue generations which need to be converted into digital format for use by the controller in determining the rotor position.

Moreover, the periods during which the windings could be used for rotor position sensing would be very short, leading to inaccuracies in determining back emf zero voltage transitions.

In accordance with the present invention, to reduce the requirement for processing power and to reduce the overall number of components required, one only of the windings 14 is used for rotor position sensing with power being applied to the remaining two windings 12, 13 continuously.

Referring to FIG. 2 it can been seen that the voltage strokes which are applied to the windings 12, 13, 14, in addition to being high or low, may also be strong or weak, although the third winding 14 which is used for rotor position sensing during four step positions only, i.e. step positions one and two and seven and eight, is provided only with strong low voltage strokes during step positions three to six and strong high voltage strokes during step positions nine to twelve. In one example, the magnitude of the weaker voltage strokes may be about 70% of the magnitude of the strong voltage strokes.

Strong high voltage strokes are switched to the first winding 12 for the first four step positions, and then during the following fifth step position, the magnitude of the voltage step is decreased to a weak high voltage stroke. For the sixth step position, a weak and low voltage step is applied, followed for the seventh to tenth step positions by a strong low voltage step. During the eleventh step position a weak low voltage step is applied and for the twelfth step position a weak high voltage step is applied.

Thus power is always switched to the first winding 12 but with the direction of the voltage stroke and the magnitude of the voltage stroke being varied.

The second winding 13 has, during the first two step positions a strong low voltage stroke applied, followed for the third step position, by a weak low voltage stroke. During the fifth step position a weak high voltage stroke is applied, followed for the fifth to the eighth step positions, with a strong high voltage stroke. For the ninth step position, the second winding 13 receives a weak high voltage stroke, and for the tenth step position the second winding 13 receives a weak low voltage stroke. For the final two step positions of the electrical revolution, the second winding 13 receives a strong low voltage stroke.

In order to synchronise the switching of power to the windings with the mechanical rotational position of the rotor, when only one of the windings 14 is used for rotor position sensing, a motor controller estimates when, from an absolute rotor position when the induced back emf in the third winding 14 undergoes a zero voltage transition, the rotor is expected to have rotated though a predetermined angle to the next position when a voltage stoke is to be applied (or maintained) to another winding 12, 13, 14.

Thus in determining a back emf zero voltage transition during the first and second step positions, from a history which indicates the likely rotational speed of the rotor, the motor controller may estimate when the rotor is expected to have rotated though predetermined angles to a rotor positions corresponding to the third, fourth, fifth and sixth step positions, and thus in accordance with such estimation, determine when to change the voltage stroke in the second winding 13 from strong low to weak low, and then to weak high and then to strong high, and when to change the voltage stroke in the first winding 12 from strong high to weak high, and then to weak low, and in the third winding 14 when to switch the strong low voltage stroke in and out, until the third winding 14 is again “floating” i.e. used for position sensing when no power is applied.

Similarly the motor controller estimates from the history and any back emf zero voltage transition detected during step positions seven and eight, when to change the voltage strokes applied to the first and second windings 13, 14 in accordance with the commutation method described.

Using the methodology of the present invention, it will be appreciated that the analogue to digital conversion of back emf voltage information for use in synchronising power switching is performed for only one third of the electrical revolution compared with a continuous such conversion albeit for each of the three windings with the prior art method, thus saving processing power, and some componentry.

It will be appreciated that in order to estimate the angular rotation of the rotor by detecting back emf zero voltage transitions in one phase winding 14 only, the controller needs an indication of the likely rotor speed which the controller can determine from back emf voltage transition information from previous mechanical rotation. However upon start-up, such information is unavailable. The rotor has to reach an acquisition speed at which the motor controller can reliably estimate the rotor angular position in order to effect the commutation method described.

In one arrangement, the motor 10 may be operated conventionally during start up e.g. by the six step commutation method described with reference to FIG. 1, until the necessary acquisition speed has been attained. This may involve storing a set of parameters, for example in an EEPROM, which are retained when the motor is powered off, and are applied to the motor 10 upon start up, particularly where for example, the start-up load is unknown. Such parameters may apply a set commutation scheme irrespective of any rotor position, to establish rotation of the motor until meaningful back emf zero transition detection can be performed to determine the position of the rotor, at which point the commutation scheme described with reference to FIG. 1 may be established and retained until the twelve step commutation scheme acquisition speed is sensed when twelve step commutation may be established in accordance with the present invention. The stored start-up parameters may include applying a voltage stroke or strokes to selected of the windings only, to move the rotor to a start reference position where the set commutation scheme initially to rotate the rotor, may be established.

The method of the present invention in which a single phase winding 14 only is used for rotor position sensing may be applied to other than motors with twelve step commutation. For example the invention could be applied to a six step commutated motor, or conveniently to any 12N commutation where N is a whole number, to any existing three phase motor.

I claim:

1. A method of operating a three phase sensorless brushless motor including a stator including three phase windings and a rotor carrying at least one permanent magnet, the method including switching power to the phase windings of the stator in synchronisation with the rotor position, by applying voltage strokes to the windings, to generate a rotating magnetic flux which interacts with the rotor flux generated by the rotor magnet, to rotate the rotor, the method including applying a plurality of voltage strokes to each of the windings for each rotation of the rotor, sensing a position of the rotor by detecting back emf voltage transitions in a third only of the windings in periods in which voltage strokes are not applied to the third winding, and estimating when the rotor is expected to have rotated though a predetermined angle to a position at which a voltage stoke is next to be applied to the or another winding, and applying the voltage stroke at the estimated time.

2. A method according to claim 1 wherein the method is a twelve step commutation method.

3. A method according to claim 2 wherein the method includes applying to at least the first and second windings, a plurality of voltage strokes of different magnitude and direction over each electrical revolution, depending upon the rotor position sensed or estimated.

4. A method according to claim 3 wherein in each electrical revolution, the first and second windings each receive a relatively strong voltage stroke in a first direction over a plurality of step positions, followed by a relatively weaker voltage stroke in the first direction over at least one step position, followed by a weak voltage stroke in a second opposite direction over at least one step position, followed by a strong voltage stroke in the second direction over a plurality of step positions, followed by a weaker voltage stroke in the second direction over at least one step position, followed by a weak voltage stroke in the first direction over at least one step position.

5. A method according to claim 4 wherein the strong voltage strokes are applied over four adjacent step positions, and the weaker voltage strokes are each applied over a single step position.

6. A method according to claim 5 wherein the voltage strokes applied in the first and second windings are offset in the electrical rotation by four step positions to one another.

7. A method according to any claim 4 wherein a strong voltage stroke in the first direction is applied to the third stator winding over a plurality of step positions, followed by a floating period over two step positions, followed by a strong voltage stroke in the second direction, followed by another floating period over two step positions.

8. A method according to claim 7 wherein each strong voltage stroke applied to the third winding in the first and second directions is applied over four step positions.

9. A method according to claim 8 wherein each strong voltage stroke applied to the third winding is followed by a corresponding high voltage stroke in a corresponding first or second direction, in one of the first and second windings.

10. A method according to claim 1 wherein the method of operating the motor includes switching between a commutation method in which voltage strokes are applied to each of the three windings such in each electrical revolution, each winding has at least one floating period during which no power is applied, and detecting back emf zero voltage transitions in each of the windings in respective floating periods.

11. A method of operating a three phase sensorless brushless motor during start up, the motor including a stator including three phase windings and a rotor carrying at least one permanent magnet, the method including applying a voltage stroke to at least one of the windings to bring the rotor to a reference start rotational position relative to the stator windings, applying voltage strokes to the windings according to a set commutation scheme irrespective of any rotor position to establish rotation of the motor until a plurality of back emf voltage transitions are sensed, then applying voltage strokes to each of the windings in synchronisation with the rotor position, and detecting back emf zero voltage transitions in a third only of the windings in a period in which voltage strokes are not applied to the third winding, and estimating when the rotor is expected to have rotated though a predetermined angle to a position at which a voltage stoke is next to be applied to the or another winding, and applying the voltage stroke at the estimated time.

12. A method according to claim 11 wherein upon a plurality of back emf voltage transitions being sensed, for a predetermined period or until the motor speed has reached a predetermined value, the method includes applying voltage strokes to each of the three windings such in each electrical revolution, each winding has at least one floating period during which no power is applied, and detecting back emf zero voltage transitions in each of the windings in respective floating periods.

13. A method according to claim 11 wherein the method of operating the motor includes switching between a commutation method in which voltage strokes are applied to each of the three windings such in each electrical revolution, each winding has at least one floating period during which no power is applied, and detecting back emf zero voltage transitions in each of the windings in respective floating periods.
